(19) United States
(12) Patent Application Publication
(10) Pub. No.: US 2019/0010327 A1
(43) Pub. Date: Jan. 10, 2019

(54) IMPROVED PERFORMANCE MONOFILAMENT MANUFACTURED ARTICLES

(71) Applicant: SABIC Global Technologies B.V., Bergen op Zoom (NL)

(72) Inventors: Robert Russell GALLUCCI, Mt. Vernon, IN (US); Malvika BIHARI, Evansville, IN (US)

(21) Appl. No.: 16/069,688

(22) PCT Filed: Jan. 12, 2017
(86) PCT No.: PCT/US2017/013172

§ 371 Date: Jul. 12, 2018

Related U.S. Application Data
(60) Provisional application No. 62/279,123, filed on Jan. 15, 2016.

(51) Int. Cl. C08L 69/00

(52) U.S. Cl. CPC C08L 69/005; D01F 1/10

(57) ABSTRACT

The present disclosure provides, inter alia, additive-manufactured articles formed from monofilaments that comprise blends of amorphous polymer, crystalline polymer, and core-shell rubber modifier. These articles exhibit improved elongation and impact over existing materials, and the disclosed technology allows for the formation of additive-manufactured articles that have mechanical properties approaching those of corresponding injection-molded articles.

### RELATED APPLICATION

The present application claims priority to and the benefit of U.S. patent application 62/279,123, “Performance Monofilament Manufactured Articles” (filed Jan. 15, 2016), the entirety of which application is incorporated herein by reference for any and all purposes.

### TECHNICAL FIELD

The present application relates to the field of polymer blend materials and to the field of additive manufacturing.

### BACKGROUND

In theory, crystalline resins provide monofilament manufactured parts with good solvent resistance. But monofilaments that are mainly (e.g., >90 wt. %) crystalline resin may have limited melt strength, thus giving rise during additive manufacturing to strings of material that fall onto the part during the part build process, which can compromise the manufacturing process in a number of ways. Because of this, existing additive manufacturing processes that use crystalline monofilaments can yield non-uniform layers in manufactured parts, which in turn results in parts that do not meet the user's desired specifications and/or performance criteria.

Commonly used polymeric materials in fused filament fabrication (FFF) processes include styrenic polymers like acrylonitrile-butadiene-styrene (ABS) as well as ABS and other blends with other polymers, such as polycarbonate (PC), polyetherimide and polyphenylsulphones. Polycarbonates are known to have particularly high impact strength as compared to other thermoplastics; as one example, injection-molded PC may have a notched Izod impact strength of 600-800 J/m.

PC parts printed by FFF processes may, however, in some instances lack impact strength, and currently available PC materials exhibit an Izod notched impact strength of about 60-70 J/m, which value is comparatively low relative to the Izod notched impact strength of corresponding injection molded parts. Likewise, FFF-made PC materials exhibit a comparatively low elongation at break (<10%) in printed parts. Similarly, ABS FFF-made materials also exhibit reduced impact strength (˜130 J/m) and elongation at break (<10%), as compared to corresponding injection-molded parts.

Accordingly, there is a long-felt need in the art for additive manufacturing materials that exhibit superior solvent resistance while also having attractive processing characteristics and while also having the ability to produce, in an additive manufacturing process (such as FFF), a part that has properties similar to those of an article made via injection molding.

### SUMMARY

In meeting the long-felt needs described above, it was found that a blend of an amorphous resin (e.g., >50 wt. %) with an amount of a crystalline resin (e.g., about >10 wt. %, about >25 wt. %, or even about >35 wt. % , which is especially preferred) of a crystalline resin yields a blend that will not drip strings, or become excessively thin while making a monofilament manufactured article and also has resistance to a wide range of chemicals and solvents in end usage. Such compositions are also suitable in other additive manufacturing processes besides FFF processes, such as so-called large format additive manufacturing (LFAM) processes, described elsewhere herein.

In some embodiments, the amorphous-crystalline resin blend may have a melt strength, low shear viscosity that is above about 1000 poise at a temperate from 20 to 50 deg. C above the Tm of the crystalline resin. In other instances at low shear rate of 10 to 100 sec⁻¹ the resin blend may have a viscosity above, for example, about 500 poise.

In some instances the phase separated amorphous crystalline blends may comprise a dispersion with an average distance of less than 20 microns between the phases. In some instances, the average phase separation may be 10 microns or less.

The blends may suitably have a melt strength sufficient to prevent stringing or excessive elongation of the molten monofilament strand or a sagging of the partially finished article. The blends also suitably have sufficient crystallinity to resist chemical attack on the finished article, e.g., attack by common solvents or other processing chemicals.

Further—and most unexpectedly—the presence of a core-shell rubber modifier (e.g., 1-25 wt. % MBS) yields blends that, when formed into additive manufactured parts using a filament deposition process, have surprisingly better impact strength and elongation, presumably due to better inter filament adhesion. This benefit is largely independent of filament orientation in the part.

In meeting the described challenges, the present disclosure first provides additively-manufactured articles, comprising: at least 10 layers made from a composition, the composition comprising an amorphous polymer phase and at least one core-shell or graft rubber modifier material, the amorphous polymer being at least 50% of the weight of the at least 10 layers of the article, the amorphous polymer having a Tg of from about 110 to about 200 deg. C, and the amorphous polymer having a molecular weight of at least 10,000 Da as per ASTM D5296 and the least one core-shell rubber modifier material, if present, having a number average diameter of from 100 to 400 nm, and being present at from about 1 to about 30% of the weight of the composition, the article further having a surface roughness with a vertical deviation of from 0.01 to 0.1 mm, and the article still further having (a) a tensile elongation at break, as per ASTM D638, of from about 20% to about 99% the elongation at break value of a corresponding injection-molded article, (b) a notched Izod impact strength, as per ASTM D256, of from about 20% to about 99% of the notched Izod impact strength of a corresponding injection-molded article, or both (a) and (b).

The present disclosure also provides methods, the methods comprising with a composition according to the present disclosure, additively manufacturing at least a portion of an article.

Further provided are additive manufacturing systems, comprising: a material delivery module configured to place a composition according to the present disclosure into a molten state and to deliver the molten composition in a programmed fashion so as to give rise to an article according to any of the aspects provided herein.

### BRIEF DESCRIPTION OF THE FIGURES

The summary, as well as the following detailed description, is further understood when read in conjunction with the appended drawings. For the purpose of illustrating the technology, there are shown in the drawings exemplary and preferred embodiments of the invention; however, the disclosure is not limited to the specific methods, compositions, and devices disclosed. In addition, the drawings are not necessarily drawn to scale. In the drawings:

FIG. 1 depicts exemplary FFF part orientations (upright, on edge, and flat) with reference to X, Y, and Z axes; as shown, parts may be built in the XY (flat), XZ (on edge), or ZX (upright) orientations; and

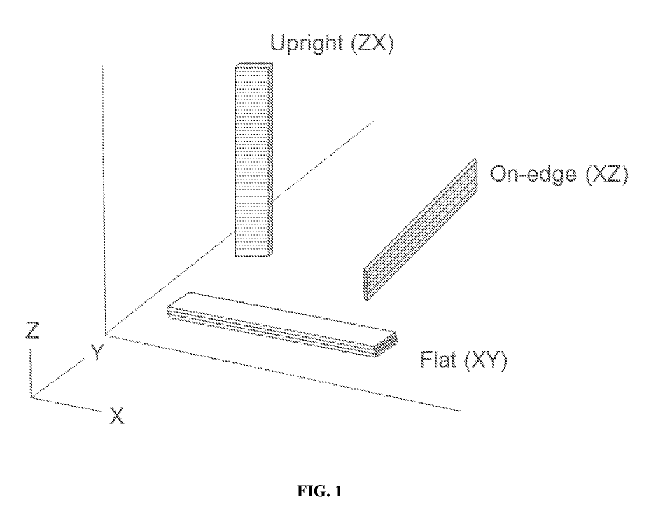

FIG. 2 provides a typical filament (raster) fill pattern for each layer of a part (applicable to all print orientations).

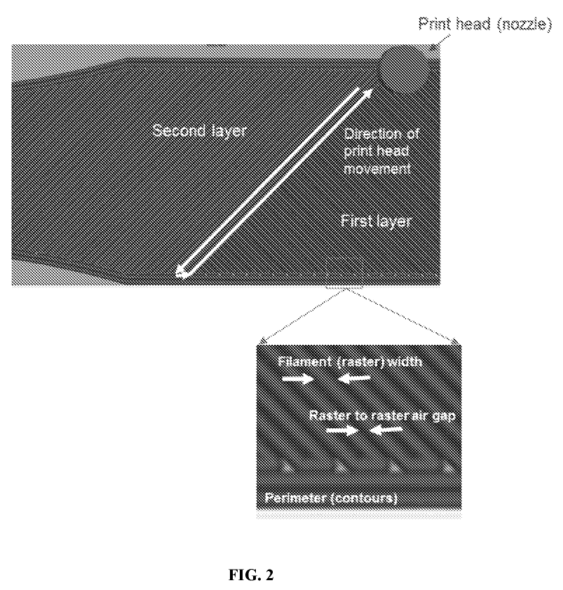

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the disclosed subject matter.

Also, as used in the specification including the appended claims, the singular forms “a,” “an,” and “the” include the plural, and reference to a particular numerical value includes at least that particular value, unless the context clearly dictates otherwise. Any documents mentioned herein are incorporated herein in their entireties for any and all purposes.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. When referring to a value, the term “about” means the value and all other values within 10% of the value. For example, “about 10” means from 9 to 11 and all intermediate values, including 10.

Weight percentages should be understood as not exceeding a combined weight percent value of 100 wt. %. Where a standard is mentioned and no date is associated with that standard, it should be understood that the standard is the most recent standard in effect on the date of the present filing.

Additive Manufacturing

Suitable additive manufacturing processes include those processes that use filaments, pellets, particulates (also termed powders), and the like, and suitable processes will be known to those of ordinary skill in the art; the disclosed compositions may be used in virtually any additive manufacturing process that uses filament, particulate, or pellet build material.

Although additive manufacturing techniques are known to those in the art, the present disclosure will provide additional information on such techniques for the sake of convenience.

In some additive manufacturing techniques, a plurality of layers is formed in a preset pattern by an additive manufacturing process. “Plurality” as used in the context of additive manufacturing includes 2 or more layers. The maximum number of layers can vary and may be determined, for example, by considerations such as the size of the article being manufactured, the technique used, the capabilities of the equipment used, and the level of detail desired in the final article. For example, 20 to 100,000 layers can be formed, or 50 to 50,000 layers can be formed.

As used herein, “layer” is a term of convenience that includes any shape, regular or irregular, having at least a predetermined thickness. In some embodiments, the size and configuration of two dimensions are predetermined, and on some embodiments, the size and shape of all three dimensions of the layer is predetermined. The thickness of each layer can vary widely depending on the additive manufacturing method. In some embodiments the thickness of each layer as formed differs from a previous or subsequent layer. In some embodiments, the thickness of each layer is the same. In some embodiments, the thickness of each layer as formed is 0.1 millimeters (mm) to 5 mm. In other embodiments, the article is made from a monofilament additive manufacturing process. For example, the monofilament may comprise a thermoplastic polymer with a diameter of from 0.1 to 5.0 mm.

The preset pattern can be determined from a three-dimensional digital representation of the desired article as is known in the art and described in further detail below. Such a representation may be created by a user, or may be based—at least in part—on a scan made of a three-dimensional real object.

Any additive manufacturing process can be used, provided that the process allows formation of at least one layer of a thermoplastic material that is fusible to the next adjacent layer. The plurality of layers in the predetermined pattern may be fused to provide the article. Any method effective to fuse the plurality of layers during additive manufacturing can be used. In some embodiments, the fusing occurs during formation of each of the layers. In some embodiments the fusing occurs while subsequent layers are formed, or after all layers are formed.

In some embodiments, an additive manufacturing technique known generally as material extrusion can be used. In material extrusion, an article can be formed by dispensing a material (“the build material,” which may be rendered flowable) in a layer-by-layer manner and fusing the layers. “Fusing” as used herein includes the chemical or physical interlocking of the individual layers, and provides a “build structure.” Flowable build material can be rendered flowable by dissolving or suspending the material in a solvent. In other embodiments, the flowable material can be rendered flowable by melting. In other embodiments, a flowable prepolymer composition that can be crosslinked or otherwise reacted to form a solid can be used. Fusing can be by removal of the solvent, cooling of the melted material, or reaction of the prepolymer composition.

In one particular embodiment, an article may be formed from a three-dimensional digital representation of the article by depositing the flowable material as one or more roads on a substrate in an x-y plane to form the layer. The position of the dispenser (e.g., a nozzle) relative to the substrate is then incremented along a z-axis (perpendicular to the x-y plane), and the process is then repeated to form an article from the digital representation. The dispensed material is thus also referred to as a “modeling material” as well as a “build material.”

In some embodiments, a support material as is known in the art can optionally be used to form a support structure. In these embodiments, the build material and the support material can be selectively dispensed during manufacture of the article to provide the article and a support structure. The support material can be present in the form of a support structure, for example, a so-called scaffolding that may be mechanically removed or washed away when the layering process is completed to a desired degree. The dispenser may be movable in one, two, or three dimensions, and may also be rotatable. Similarly, the substrate may also be moveable in one, two, or three dimensions, and may also be rotatable.

Systems for material extrusion are known. One exemplary material extrusion additive manufacturing system includes a build chamber and a supply source for the thermoplastic material. The build chamber may include a build platform, a gantry, and a dispenser for dispensing the thermoplastic material, for example an extrusion head.

The build platform is a platform on which the article is built, and desirably moves along a vertical z-axis based on signals provided from a computer-operated controller. The gantry is a guide rail system that can be configured to move the dispenser in a horizontal x-y plane within the build chamber, for example based on signals provided from a controller. The horizontal x-y plane is a plane defined by an x-axis and a y-axis where the x-axis, the y-axis, and the z-axis are orthogonal to each other.

Alternatively, the platform can be configured to move in the horizontal x-y plane and the extrusion head can be configured to move along the z-axis. Other similar arrangements can also be used such that one or both of the platform and extrusion head are moveable relative to each other. The build platform can be isolated or exposed to atmospheric conditions. The distance between the platform and head may be adjustable, as may be the orientation of the head and platform relative to one another. It should be understood that the platform may be heated, cooled or maintained at ambient temperature, depending on the user's needs.

In some embodiments, both the build structure and the support structure of the article formed can include a fused expandable layer. In other embodiments, the build structured includes a fused expandable layer and the support material does not include an expandable layer. In still other embodiments, the build structure does not include an expandable layer and the support structure does include a fused expandable layer. In those embodiments where the support structure includes an expandable layer, the lower density of the expanded layer can allow for the support material to be easily or more easily broken off than the non-expanded layer, and re-used or discarded.

In some embodiments, the support structure can be made purposely breakable, to facilitate breakage where desired. For example, the support material may have an inherently lower tensile or impact strength than the build material. In other embodiments, the shape of the support structure can be designed to increase the breakability of the support structure relative to the build structure.

For example, in some embodiments, the build material can be made from a round print nozzle or round extrusion head. A round shape as used herein means any cross-sectional shape that is enclosed by one or more curved lines. A round shape includes circles, ovals, ellipses, and the like, as well as shapes having an irregular cross-sectional shape. Three dimensional articles formed from round shaped layers of build material can possess strong structural strength. In other embodiments, the support material for the articles can be can made from a non-round print nozzle or non-round extrusion head. A non-round shape means any cross-sectional shape enclosed by at least one straight line, optionally together with one or more curved lines. A non-round shape can include squares, rectangles, ribbons, horseshoes, stars, T-head shapes, X-shapes, chevrons, and the like. These non-round shapes can render the support material weaker, brittle and with lower strength than round shaped build material.

The above material extrusion techniques include techniques such as fused deposition modeling and fused filament fabrication as well as others as described in ASTM F2792-12a. In fused material extrusion techniques, an article can be produced by heating a thermoplastic material to a flowable state that can be deposited to form a layer. The layer can have a predetermined shape in the x-y axis and a predetermined thickness in the z-axis. The flowable material can be deposited as roads as described above, or through a die to provide a specific profile. The layer cools and solidifies as it is deposited. A subsequent layer of melted thermoplastic material fuses to the previously deposited layer, and solidifies upon a drop in temperature. Extrusion of multiple subsequent layers builds the desired shape. In some embodiments at least one layer of an article is formed by melt deposition, and in other embodiments, more than 10, or more than 20, or more than 50 of the layers of an article are formed by melt deposition, up to and including all of the layers of an article being formed by melt deposition.

In some embodiments the thermoplastic polymer is supplied in a melted form to the dispenser. The dispenser can be configured as an extrusion head. The extrusion head can deposit the thermoplastic composition as an extruded material strand to build the article. Examples of average diameters for the extruded material strands can be from 1.27 millimeters (0.050 inches) to 3.0 millimeters (0.120 inches). The foregoing dimensions are exemplary only and do not serve to limit the scope of the present disclosure.

So-called large format additive manufacturing (LFAM) systems are also within the scope of the present disclosure; such systems may utilize pellets of polymeric material according to the present disclosure to form parts. Pellets having a cross-sectional dimension in the range of from about 0.1 mm to about 50 mm and/or an aspect ratio in the range of from about 1 to about 10 are considered especially suitable for LFAM applications.

In a LFAM system, a comparatively large extruder converts pellets to a molten form that are then deposited on a table. A LFAM system may comprise a frame or gantry that in turn includes a print head that is moveable in the x,y and/or z directions. (The print head may also be rotatable.) Alternately, the print head may be stationary and the part (or the part support) is moveable in the x, y and/or z axes. (The part may also be rotatable.)

A print head may have a feed material in the form of pellets and/or filament and a deposition nozzle. The feed material may be stored in a hopper (for pellets) or other suitable storage vessel nearby to the print head or supplied from a filament spool.

An LFAM apparatus may comprise a nozzle for extruding a material. The polymeric material is heated and extruded through the nozzle and directly deposited on a building surface, which surface may be a moveable (or stationary) platform or may also be previously-deposited material. A heat source may be positioned on or in connection with the nozzle to heat the material to a desired temperature and/or flow rate. The platform or bed may be heated, cooled, or left at room temperature.

In one non-limiting embodiment, a nozzle may be configured to extrude molten polymeric material (from melted pellets) at, e.g., about 10-100 lbs/hr through a nozzle onto a print bed. The size of a print bed may vary depending on the needs of the user and can be room-sized. As one example, a print bed may be sized at, e.g., about 160×80×34 inches. A LFAM system may have one, two, or more heated zones. A LFAM system may also comprise multiple platforms and even multiple print heads, depending on the user's needs.

One exemplary LFAM method is known as big area additive manufacturing (BAAM; e.g., Cincinnati Incorporated, http://www.e-ci.com/baam/). LFAM systems may utilize filaments, pellets, or both as feed materials. Exemplary description of a BAAM process may be found in, e.g., US 2015/0183159, US 2015/0183138, US 2015/0183164, and U.S. Pat. No. 8,951,303, all of which are incorporated herein by reference in their entireties. The disclosed compositions are also suitable for droplet-based additive manufacturing systems, e.g., the Freeformer™ system by Arburg (https://www.arburg.com/us/us/products-and-services/additive-manufacturing/).

Additive manufacturing systems may use materials in filament form as the build material. Such a system may, as described, effect relative motion between the filament (and/or molten polycarbonate) and a substrate. By applying the molten material according to a pre-set schedule of locations, the system may construct an article in a layer-by-layer fashion, as is familiar to those of ordinary skill in the art. As described elsewhere herein, the build material may also be in pellet form.

Suitable additive manufacturing processes for the disclosed technology also include so-called powder bed technologies, such as binder jetting, drop-on powder, inkjet head 3D printing (3DP), electron-beam melting, selective laser melting, selective laser sintering, high-speed sintering, so-called multi jet fusion, and the like. In such processes, an amount of a powder is deposited layer-wise onto a substrate, and various methods (heating, chemical binding) are then used to fuse together powder at a particular region or regions of the deposited layer. In this fashion, a three-dimensional object may be built up layer-wise.

Exemplary Aspects

The following non-limiting aspects are illustrative only and do not serve to limit the scope of the present disclosure.

Aspect 1. An additively-manufactured article, comprising: at least 10 layers made from a composition, the composition comprising an amorphous polymer phase and at least one core-shell or graft rubber modifier material, the amorphous polymer being at least 50% of the weight of the at least 10 layers of the article, the amorphous polymer having a Tg of from about 110 to about 200 deg. C, and the amorphous polymer having a molecular weight of at least 10,000 Da as per ASTM D5296 and the least one core-shell rubber modifier material, if present, having a number average diameter of from 100 to 400 nm, and being present at from about 1 to about 30% of the weight of the composition, the article further having a surface roughness with a vertical deviation of from 0.01 to 0.1 mm, and the article still further having (a) a tensile elongation at break, as per ASTM D638, of from about 20% to about 99% the elongation at break value of a corresponding injection-molded article, (b) a notched Izod impact strength, as per ASTM D256, of from about 20% to about 99% of the notched Izod impact strength of a corresponding injection-molded article, or both (a) and (b).

The at least one core-shell rubber modifier material may be in particle form and may have a number average diameter of from about 100 to about 400 nm. The modifier may be present at from about 1 to about 30% of the weight of the composition. As described elsewhere, the composition may be in monofilament form, and the monofilament used to make the at least 10 layers article may a diameter of from 1 to 5 mm. As one example, a monofilament may have a diameter of about 1.75 mm, or even about 1.78 mm.

Suitable raft rubbers include, for example, copolymers of styrene and gacrylonitrile, copolymers of alpha-methylstyrene and acrylonitrile, methyl methacrylate polymers and copolymers. Specific examples of monovinylidene aromatic graft copolymers include but are not limited to the following: acrylonitrile-butadiene-styrene (ABS), acrylonitrile-styrene-butyl acrylate (ASA), methyl methacrylate-acrylonitrile-butadiene-styrene (MABS), acrylonitrile-ethylene-propylene-non-conjugated diene-styrene (AES). In some instances the graft or core shell modifier may have a rubber content of 50 wt. % or more, in other instances the rubber content may be 70 wt % or more.

The article may, in some embodiments, have a grooved upper surface, wherein the grooves are spaced, on average, from 0.1 to about 5 mm from each other when measured orthogonal from the direction in which the monofilament strands were deposited to make the upper surface of the article. An article according to the present disclosure may also have (a) a density as measured by ASTM D792 of 80.0% to 99.5% by weight of a corresponding solid standard injection molded article. In some embodiments, the article may The article of any of claims 1-3, wherein the article have a notched Izod impact strength, per ASTM D256, of above about 300 J/m.

Aspect 2. The article of aspect 1, wherein the composition comprises at least 50 ppm of a phosphorous compound having a molecular weight of over 300 Daltons and comprising a phosphate, mixtures of phosphates or mixtures thereof. If present, aryl phosphite may be at a lower concentration than aryl phosphate.

An article may comprise at least 100 ppm of a mixture of aryl phosphate and aryl phosphite, each of the aryl phosphate and the aryl phosphite having a molecular weight of at least 300 Daltons. The aryl phosphate may have a molecular weight of less than 5000 Da; the aryl phosphite may also have a molecular weight of less than 5000 Da. When present, the mixture of aryl phosphate and aryl phosphite may be present at less than 50000 ppm. In some embodiments, the aryl phosphate is present in a greater amount than the aryl phosphite.

Aspect 3. The article of any of aspects 1-2, wherein the composition further comprises a hindered phenol antioxidant comprising at least about 20 carbon atoms, e.g., from about 20 to about 500, to about 400, to about 300, to about 200, or even to about 100 carbon atoms.

Hindered phenols may be of the type in which there is a sterically hindered phenolic group, especially one containing a t-butyl group in the ortho position to the phenolic OH group. Examples of such compounds are many. Examples are, tetrakis (methylene-3-(-3′,5′-di-tert-butyl-4′-hydroxyphenyl)-propionate) methane; octadecyl-3-(3′,5′-di-tert-butyl-4′-hydroxyphenyl) propionate; 1,3,5-trimethyl-2,4,6-tris(3,5-di-tert-butyl-4-hydroxybenzyl)benzene; 2,2′-thiodiethylbis(3-(3,5-di-tert-butyl-4-hydroxyphenyl))propionate; octadecyl-3,5-di-tert-butyl-4-hydroxyhydrocinnamate and mixtures of any of the foregoing. In some instances octadecyl-3,5-di-tert-butyl-4-hydroxyhydrocinnamate, which is commercially available as “IRGANOX”™ 1076 is useful. Further examples of the above-mentioned phenolic antioxidant include known compounds, for example, monophenolic compounds such as, 2,6-di-t-butyl-4-ethylphenol and octadecyl-3-(3,5-di-t-butyl-4-hydroxyphenyl) propionate, bisphenolic compounds such as 2,2′-methylene-bis-(4-methyl-6-t-butylphenol), 2,2′-methylene-bis-(4-ethyl-6-t-butylphenol), and 4,4′-butylidenebis-(3-methyl-6-di-t-butylphenol), and high-molecular phenolic compounds such as 1,1,3-tris(2-methyl-4-hydroxy-5-t-butylphenyl)butane, tetrakis[methylene-3-(3′,5′-di-t-butyl-4′-hydroxyphenyl) propionate]methane, bis[3,3′-bis(4′-hydroxy-3′-t-butylphenyl)butyric acid]glycol ester and the like. They can each be used in an amount of 0.001 to 2.0 wt. %, preferably 0.05 to 1.0 wt. % based on the composition.

Aspect 4. The article of any of aspects 1-3, wherein the article has a notched Izod impact strength, as per ASTM D256, of from about 20% to about 99%, e.g., from about 55% to about 95%, from about 60% to about 90%, from about 65% to about 85%, from about 70% to about 75% of the notched Izod impact strength of a corresponding injection-molded article, i.e., an injection-molded article formed from the same material as the material of the monofilament.

Aspect 5. The article of any of aspects 1-4, wherein the article is characterized as having a surface roughness with a vertical deviation of from 0.01 to 0.1 mm, e.g., from about 0.05 to about 0.5, or from about 0.1 to about 0.3 mm.

Aspect 6. The article of any of aspects 1-5, wherein at least some of the at least 10 layers have a micro structure, as measured by optical microscopy, containing from 1% to 20% by volume of voids. In some embodiments, at least 60% of the voids are high aspect voids and less than 20% of the voids are spherical voids with a diameter of from about 10 to about 100 microns. (By high aspect is meant an aspect ratio of 2:1 or greater, e.g., a void that is twice as long as it is wide, a void that is three time as long as it is wide, and so on.)

An article may have a microstructure that comprises from about 0.5 to about 20 volume % voids, as measured using a section of the article that is made at 90 to 180 degrees from the direction in which the strands were deposited to make the article. The voids may have, on a number average basis, an aspect ratio of between about 2:1 and about 100:1. The voids may have, on a number average basis, an average cross-sectional dimension of from about 10 to about 100 micrometers.

Aspect 7. The article of any of aspects 1-6, wherein the composition is in monofilament form and the monofilament has a variation along its diameter of less than about 100 micrometers, e.g., about 95, about 90, about 85, about 80, about 75, about 70, about 65, about 60, about 50, about 55, about 45, about 40, about 35, about 30, about 25, about 20 mm, or less.

Aspect 8. The article of aspect 7, wherein the monofilament comprises a plurality of concavities, a plurality of protrusions, or both. A concavity may be a groove, a trench, a slot, a cutout, and the like. A protrusion may be a ridge, a spike, a bulge, and the like.

Aspect 9. The article of aspect 8, wherein the plurality of concavities, a plurality of protrusions, or both, is oriented within about 10 degrees of the major axis of the filament.

Aspect 10. The article of any of aspects 1-9, wherein the amorphous polymer is an aryl polycarbonate with a Tg of from about 130 to about 200 deg. C and having a phenolic end group content of less than 50 ppm.

It should be understood that polycarbonate is a particularly suitable amorphous polymer, but other amorphous polymers may be used, e.g., PMMA, PS, PVC, SAN, COC, ABS, and others.

The amorphous polymer may have a Tg from about 110 to about 200 deg. C, and may comprise one or more of PC, PPO, PPC, PCE, PS, PSu, HIPS, ABS, SAN, PMMA or any combination thereof. In some embodiments, the amorphous polymer comprises PC having phenolic end groups at less than 50 ppm.

Aspect 11. The article of any of aspects 1-10, wherein the composition further comprises a crystalline polymer phase. In some embodiments, the amorphous polymer phase and the crystalline polymer phase are separated, on average, by less than about 20 micrometers when measured by electron microscopy.

The crystalline polymer may be at least 10% (on a weight basis of the monofilament) of the at least 10 layers. The crystalline polymer may have a Tm of above about 150 deg C, e.g., from about 150 to about 280 deg. C, and a molecular weight of at least 10,000 Da, as determined by ASTM D5296.

Aspect 12. The article of aspect 11, wherein the crystalline polymer has a Tm of from about 200 to about 250 deg. C. The crystalline polymer may have a carboxylic acid end group content from about 10 to about 60 meq/kg.

Aspect 13. The article of any of aspects 11-12, wherein the crystalline phase comprises a polyester, a polyamide, or both. The polyamide may comprise nylon 6; 6,6; 6,6,6; 12; 11; 6,12; or any combination thereof. A polyester or polyamide may have a Tg of greater than about 40 deg. C. A polyester or polyamide may have a Tm of from about 200 to about 280 deg. C.

Aspect 14. The article of aspect 13, wherein the polyester comprises one or more of PBT, PET, PPT and PEN. The polyester may have a carboxylic end group content of at least about 20 ppm, e.g., about 20, 25, 30, 35, 40, 45, 50, 55, 60, 65, 70, 75, 80, 85, 90, 95, 100, 105, 110, 115, 120, 125, ppm or even greater.

Aspect 15. The article of any of aspects 1-14, wherein the composition comprises polycarbonate and a polyester. The composition may comprise an acidic quencher present at 0.05 to 3.0 wt. % measured against the weight of the composition (e.g., monofilament) material used to make the article, and wherein the acidic quencher comprises one or more of: acidic phosphate salts, polyacid pyrophosphates and salts thereof, phosphate salts of a Group IB or Group IIB metals and phosphorous oxo-acids, or any combination thereof.

The acidic phosphate salts include sodium dihydrogen phosphate, mono zinc phosphate, potassium hydrogen phosphate, calcium hydrogen phosphate and the like. The phosphate salts of a Group IB or Group IIB metal include zinc phosphate, copper phosphate and the like. The phosphorous oxo acids include phosphorous acid, phosphoric acid, polyphosphoric acid or hypophosphorous acid.

The quencher may comprise phosphorous containing oxo-acids at 0.1 to 1.0 wt. %, a phosphorous containing oxo-acid salts at 0.2 to 2.0 wt. %, or any combination thereof. The article may have a total phosphorus content of less than about 1% of the weight of the filament. The composition may comprise a higher concentration of phosphite than phosphate, and articles made from the composition may have a higher concentration of phosphate than phosphite.

A polyacid pyrophosphate may be of the formula: M^{z}ₓH_{y}PₙO₃ₙ₊₁ wherein M is a metal, x is a number ranging from 1 to 12 and y is a number ranging 1 to 12, n is a number from 2 to 10, z is a number from 1 to 5 and the sum of (xz)+y is equal to n+2. These compounds include Na₃ HP₂O₇ ; K₂H₂P₂O₇ ; Na₄P₂O₇ ; KNaH₂ PO₇ and Na₂ H₂P₂O₇. The particle size of the polyacid pyrophosphate should be less than 50 microns and most often for best impact less than 10 microns.

The phosphorous oxo acids may be of the formulas:

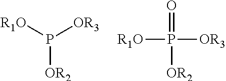

where R₁, R₂, and R₃ are independently selected from the group consisting of hydrogen, alkyl and aryl with the proviso that at least one of R₁, R₂, and R₃ is hydrogen.

Aspect 16. The article of any of aspects 1-15, wherein the composition when melted has a viscosity, as measured by ISO method 11443:2005 at a shear rate of between 10 and 100 sec⁻¹, above about 500 poise at a temperature from 30 to 100 deg. C above the Tm of the crystalline polymer. In some embodiments, the composition when melted has a viscosity, at a shear rate of between about 10 and about 100 sec⁻¹, that is above about 1000 poise at a temperate from 30 to 100 deg. C above the Tm of the crystalline polymer, determined according to ISO 11443:2005.

Aspect 17. The article according to any of aspects 1-16, wherein the shell of the core shell rubber modifier, if present, comprises from 5 to 30 wt. % of the modifier and wherein the rubbery core comprises 70 to 95 wt. % of the core shell rubber modifier.

Aspect 18. The article of any of aspects 1-17, wherein the core shell rubber modifier, if present, (a) comprises a shell comprising any combination of alkyl acrylates, alkyl methacrylates, glycidyl methacrylate, styrene, methyl styrenes and acrylonitrile and (b) comprises a core comprising a butadiene, alkyl acrylate, or silicone acrylate rubber having a Tg of less than 30 deg. C.

The core shell rubber modifier, when present, may have an average characteristic dimension, on a number average basis, of between about 100 nm and about 400 nm. The core shell rubber modifier, on a number average basis, may have a rubber core that represents at least 90% of the weight of the core shell rubber modifier.

In some embodiments, the core shell rubber modifier comprises a shell that comprises any combination of alkyl acrylates, alkyl methacrylates, glycidyl methacrylate, styrene, methyl styrenes, acrylonitrile and the core comprise a poly butadiene or poly alkyl acrylate rubber with a Tg of less than 30° C., and wherein the shell comprises from 5 to 30 wt. % of the core shell rubber modifier and wherein the rubbery core comprises 70 to 95 wt. % of the modifier. In some embodiments, the core shell rubber modifier, on a number average basis, has a shell that represents less than about 10% of the weight of the core shell rubber modifier. A core-shell modifier may comprise HRG-ABS, MBS, acrylic rubber, and any copolymer or combination thereof.

Aspect 19. The article of any of aspects 1-18, wherein the core-shell modifier, if present, comprises MBS, HRG-ABS, acrylic rubber or any combination thereof. MBS is considered particularly suitable.

Aspect 20. The article of any of aspects 1-19, wherein the composition comprises from about 0.1 to about 10.0 wt. % titanium dioxide (TiO₂). The titanium dioxide may have a particle size from about 2 to about 15 microns, and may be encapsulated in a silica, alumina or silica-alumina shell.

Aspect 21. The article of any of aspects 1-20, wherein the article forms at least part of a lighting fixture, an electrical device, a communication device, a computer, a connector, a phone, a duct, a support, a strut, a medical device, an eyeglass frame, footwear, cookware, sports equipment, handles, automotive parts, gears, gaming pieces, decorative items, sculptures, jewelry, artwork, or any combination thereof.

Aspect 22. The article of any of aspects 1-21, wherein the composition is in filament form.

Aspect 23. The article of any of aspects 1-21, wherein the composition is in pellet form. Suitable pellets are described elsewhere herein, e.g., the pellets described in connection with LFAM fabrication techniques. The composition may also be in powder form. A powder may have, e.g., a Dv50 of from between about 10 and about 200 micrometers. In some embodiments, the powder may be essentially free of particulates less than about 1 micrometer in diameter, essentially free of particulates less than about 5 micrometers in diameter, or even essentially free of particulates less than about 10 micrometers in diameter, based on the equivalent spherical size of the at least partially crystalline polyetherimide particulates. A powder may include a flow promoter.

Aspect 24. A method, comprising: with a composition according to any of aspects 1-23, additively manufacturing at least a portion of an article. The additively manufacturing may comprise fused filament fabrication, large format additive manufacturing, or both.

Aspect 25. A monofilament manufactured article, comprising: a plurality of layers made from a monofilament that comprises an amorphous polymer phase and a core-shell rubber or graft rubber modifier particulate, the amorphous polymer being at least 50% of the weight of the filament, the amorphous polymer having a Tg of from about 110 to about 200 deg. C, and the amorphous polymer having a molecular weight of at least 10,000 Da determined using gel permeation chromatography (GPC) as per ASTM method D5296.

The core-shell rubber modifier may be present at from about 1 to about 30% of the weight of the monofilament., e.g., about 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30 wt. %.

Aspect 26. The article of aspect 25, wherein the amorphous polymer has a Tg from 110 to 200 C and comprises one or more of PC, PPO, PPC, PCE, PS, PSu, HIPS, ABS, SAN, PMMA or any combination thereof.

Aspect 27. The article of aspect 23, wherein the amorphous polymer comprises polycarbonate (PC) having phenolic end groups at less than 50 ppm.

Aspect 28. The article of any of aspects 22-24, further comprising a crystalline polymer phase, the crystalline polymer being at least 10% of the weight of the filament and the crystalline polymer having a Tm above 150 deg. C and a molecular weight of at least 10,000 Da, as determined by ASTM D5296.

Aspect 29. The article of aspect 25, wherein the crystalline polymer comprises a polyester, a polyamide, or both.

Aspect 30. The article of aspect 29, wherein the polyester comprises one or more of PBT, PET, PPT, or PEN.

Aspect 31. The article of any of aspects 29-30, wherein the polyamide comprises nylon 6; 6,6; 6,6,6; 12; 11; 6,12; or any combination thereof.

Aspect 32. The article of any of aspects 25-31, wherein the amorphous polymer phase and the crystalline polymer phase are separated, on average, by less than about 20 micrometers when measured by electron microscopy.

Aspect 33. The article of any of aspects 25-32, wherein the monofilament when melted has a viscosity, at a shear rate of between about 10 and about 100 sec⁻¹, that is above about 500 poise at a temperate from 30 to 100 deg. C above the Tm of the crystalline polymer, determined according to ISO 11443:2005.

Aspect 34. The article of any of aspects 25-33, wherein the monofilament when melted has a viscosity, at a shear rate of between about 10 and about 100 sec⁻¹, that is above about 1000 poise at a temperate from 30 to 100 deg. C above the Tm of the crystalline polymer, determined according to ISO 11443:2005.

Aspect 35. The article according to any of aspects 25-34, wherein the core shell rubber modifier has an average characteristic dimension, on a number average basis, of between about 100 nm and about 400 nm.

Aspect 36. The article according to any of aspects 25-35, wherein the core shell rubber modifier, on a number average basis, has a rubber core that represents at least 90% of the weight of the core shell rubber modifier.

Aspect 37. The article according to any of aspects 25-36, wherein the core shell rubber modifier comprises a shell that comprises any combination of alkyl acrylates, alkyl methacrylates, glycidly methacrylate, styrene, methyl styrenes, acrylonitrile and the core comprise a poly butadiene or poly alkyl acrylate rubber with a Tg of less than 30° C., and wherein the shell comprises from 5 to 30 wt. % of the core shell rubber modifier and wherein the rubbery core comprises 70 to 95 wt. % of the modifier.

Aspect 38. The article of any of aspects 25-37, wherein the core shell rubber modifier, on a number average basis, has a shell that represents less than about 10% of the weight of the core shell rubber modifier.

Aspect 39. The article of any of aspects 25-38, wherein the core-shell modifier comprises HRG-ABS, MBS, acrylic rubber, and any copolymer or combination thereof.

Aspect 40. The article of any of aspects 25-39, wherein the filament is characterized as having a diameter of from about 0.3 to about 5 mm.

Aspect 41. The article of aspect 40, wherein the filament is characterized as having a diameter of from about 1 to about 4 mm.

Aspect 42. The article of any of aspects 25-41, wherein the filament has a variation along its diameter of less than about 100 micrometers.

Aspect 43. The article of any of aspects 25-42, wherein the filament comprises a plurality of concavities, a plurality of protrusions, or both.

Aspect 44. The article of aspect 43, wherein the plurality of concavities, a plurality of protrusions, or both, is oriented within about 10 degrees of the major axis of the filament.

Aspect 45. The article of any of aspects 25-44, the filament further comprising an amount of TiO₂.

Aspect 46. The article of any of aspects 25-45, wherein the filament comprises from about 0.1 to about 10 wt. % TiO₂.

Aspect 47. The article of aspects 45 or 46, wherein the TiO₂ particle size is from 3 to 10 microns and is encapsulated in a silica, alumina or silica alumina shell.

Aspect 48. The article of any of aspects 25-47, further comprising an amount of an acidic quencher present at from about 0.01 to about 3.0 wt. %.

Aspect 49. The article of aspect 48, wherein the quencher comprises a phosphorous containing oxo-acids at 0.1 to 1.0 wt. %, a phosphorous containing oxo-acid salts at 0.2 to 2.0 wt. %, or any combination thereof.

Aspect 50. The article of any of aspects 25-49, further comprising a total phosphorus content of less than about 1% of the weight of the filament.

Aspect 51. The article of any of aspects 25-50, wherein the filament comprises a higher concentration of phosphite than phosphate, and wherein articles made from the filament have a higher concentration of phosphate than phosphite.

Aspect 52. The article of any of aspects 25-51, wherein the article has a microstructure that comprises from about 0.5 to about 20 vol. % voids, as measured using a section of the article that is made at 90 to 180 degrees from the direction in which the strands were deposited to make the article.

Aspect 53. The article of aspect 52, wherein the voids, on a number average basis, have an aspect ratio of between about 2:1 and about 100:1.

Aspect 54. The article of any of aspects 52-53, wherein the voids have, on a number average basis, an average cross-sectional dimension of from about 10 to about 100 micrometers.

Aspect 55. The article of any of aspects 25-54, wherein the article is characterized as having a surface roughness with a vertical deviation of from 0.01 to 0.1 mm, when measured at 90 to 180 degrees from the direction in which the strands were deposited to make the article.

Aspect 56. The article of any of aspects 25-55, wherein the article comprises a grooved surface, wherein the grooves are spaced, on average, from 0.1 to about 1 mm from each other when measured at 90 to 180 degrees from the direction in which the strands were deposited to make the article.

Aspect 57. The article of any of aspects 25-56, further comprising at least 100 ppm of an aryl phosphate having a molecular weight of at least 300 Daltons.

Aspect 58. The article of any of aspects 25-57, further comprising at least 100 ppm of a mixture of aryl phosphate and aryl phosphite, each of the aryl phosphate and the aryl phosphite having a molecular weight of at least 300 Daltons.

Aspect 59. The article of aspect 58, wherein the aryl phosphate has a molecular weight of less than 5000 Da.

Aspect 60. The article of aspect 58 or aspect 59, wherein the aryl phosphite has a molecular weight of less than 5000 Da.

Aspect 61. The article of any of aspects 58-60, wherein the mixture of aryl phosphate and aryl phosphite is present at less than 50000 ppm.

Aspect 62. The article of any of aspects 58-61, wherein the aryl phosphate is present in a greater amount than the aryl phosphite.

Aspect 63. The article of any of the foregoing aspects, wherein the article has a density of from about 80 to about 99% of a corresponding injection-molded article, and wherein the article contains at least 0.5 volume % of non-spherical voids.

Aspect 64. The article of any of the foregoing aspects, wherein the article has a notched Izod impact strength, as per ASTM D256, of from about 20% to about 99% the notched Izod impact strength of a corresponding injection-molded article.

Aspect 65. The article of any of the foregoing aspects, wherein the article has a tensile elongation at break, as per ASTM D638, of from about 20% to about 99% elongation at break value of a corresponding injection-molded article.

Aspect 66. The article of any of the foregoing aspects, wherein the article comprises at least 10 layers, and wherein the layers alternate in an overlapping pattern wherein at least half of the layers intersect at an angle of from 60 to 120 degrees.

Aspect 67. The article of any of the foregoing aspects, wherein the article has a yellowness index of 2.0 to 20.0.

Aspect 68. The article of any of the foregoing aspects, further comprising a hindered phenol antioxidant comprising at least 20 carbon atoms.

Aspect 69. The article of any of the foregoing aspects, further comprising 0.1 to 5.0 wt. % of a benzotriazole UV absorber having at least 20 carbon atoms.

Aspect 70. The article of any of the foregoing aspects, wherein the article forms at least part of a lighting fixture, an electrical device, a communication device, a computer, a connector, a phone, a duct, a support, a strut, a medical device, an eyeglass frame, footwear, cookware, sports equipment, handles, automotive parts, gears, gaming pieces, decorative items, sculptures, jewelry, artwork, or any combination thereof. Snap-fit connectors according to the present disclosure are considered especially suitable articles.

Aspect 71. An additive manufacturing system, comprising: a material delivery module configured to place a filament material into a molten state and to deliver the molten filament material in a programmed fashion so as to give rise to an article according to any of the foregoing aspects.

A system may be, e.g., a 3-D printing system, which systems are well-known to those of skill in the art. The system may have, disposed within, an amount of a monofilament according to the present disclosure, e.g., in an FFF system.

Alternatively, a system may be a LFAM system. Exemplary such systems are described elsewhere herein.

### Illustrative Embodiments

The following examples are shown as illustrations of the invention. Examples of the invention are designated by number, control examples are designated by letter.

TABLE 1
Materials

| Raw Material | Description | Supplier |
|---|---|---|
| PC | BPA PC, LEXAN 141, Mw 27,000 (PC Stds), <10 | SABIC |
| | ppm OH end groups Tg = 149 C. | |
| PC Mw 21,900 | BPA PC, LEXAN HF, Mw 21,900 (PC Stds), <10 | SABIC |
| | ppm OH end groups Tg = 148 C. | |
| PC Mw 29,900 | BPA PC, LEXAN 101, Mw 29,900 (PC Stds), <10 | SABIC |
| | ppm OH end groups Tg = 149 C. | |
| PBT | PBT, VALOX 315 Mw 36,500 COOH end groups 47 | SABIC |
| | meq/Kg, Tm = 225 C. | |
| EMA-GMA | Terpolymer Ethylene - Acrylic Ester - Glycidyl | Arkema |
| | Methacrylate: LOTADER AX8900 | |
| MBS | Methyl methacrylate styrene polybutadiene core shell | Dow/Rohm & |
| | rubber, EXL2691A | Haas |
| Acrylic Rubber | Methyl methacrylate, butyl acrylate core shell rubber, | Dow/Rohm & |
| | EXL2330 | Haas |
| Silicone Acrylic | Methyl methacrylate, butyl acrylate silicone core shell | Mitsubishi Rayon |
| Rubber | rubber (METABLEN S-2001) | |
| ABS Rubber | Acrylonitrile styrene butadiene graft rubber, 70% | Chemtura |
| | polybutadiene, (BLENDEX 338) | |
| VHRG ABS Rubber | Acrylonitrile styrene butadiene graft rubber, 70% | SABIC |
| | polybutadiene, (CYCOLAC 362) | |
| ASA Rubber | Acrylonitrile styrene butyl acrylate graft rubber, BA | SABIC |
| | content ~32%, S/AN ratio ~33/67 particle size 270 nm | |
| Hindered Phenol | Octadecyl 3-(3,5-di-tert-butyl-4- | Novartis |
| | hydroxyphenyl)propionate, IRGANOX 1076, | |
| | C₃₅H₆₃O₃, Mw = 531.9 | |
| Phosphate salt | MZP = mono zinc phosphate dihydrate; Zn[(H₂PO₄)]₂, | Gallard - |
| quencher | SDP = sodium hydrogen phosphate; NaH₂PO₄ | Schlesinger |
| Benzotriazole UVA | 2-(2-hydroxy-5-tert-octyl phenyl) benzotriazole | Novartis |
| | TINUVIN 234, C₃₀H₂₉N₃O, Mw = 447.6 | |
| Thioester | Pentaerythritol tetrakis (β-laurylthiopropionate, | Addivant |
| | SEENOX 412S, C₆₅H₁₂₄O₈S₄, Mw = 1161.9 | |
| Phosphite | tris (2,4--di tert butyl phenyl) phosphite, IRGAFOS | Novartis |
| | 168, C₄₂H₆₃O₃P, Mw = 646.9 | |
| PETS | Penta Erythritol Tetra Stearate, C₇₇H₁₄₈O₈, Mw = | Lonza |
| | 1201.1 | |

The specific formations used in the polycarbonate-polyester (PC-PBT) and polycarbonate (PC) examples provided below in Tables 2 and 3.

TABLE 2
PC-PBT Blends

| | | PC-PBT- | |
|---|---|---|---|
| Composition | PC-PBT | EMA/GMA | PC-PBT-MBS |
| PC | 49.82 | 67.32 | 49.02 |
| PBT | 50 | 30 | 40 |
| EMA-GMA | | 2.0 | |
| MBS | | | 10.5 |
| Hindered Phenol | 0.08 | 0.08 | 0.08 |
| Phosphate salt quencher | 0.1 MZP | 0.3 SDP | 0.1 MZP |
| Benzotriazole UVA | | 0.25 | 0.25 |
| Thioester | | 0.05 | 0.05 |
| Phosphite | | 0.08 | 0.20 |

TABLE 3
PC Blends

| Composition | PC | PC-MBS |
|---|---|---|
| PC | 99.68 | 94.68 |
| MBS | | 5.0 |
| Phosphite | 0.05 | 0.05 |
| PETS Release | 0.27 | 0.27 |

The compositions of Table 2 combined a BPA polycarbonate (PC) of Mw 27,000 with a polybutylene terephthalate (PBT) of Mw 36,500 (Mw determined as per ASTM 5296, using PC standards).

The PC had less than 10 ppm phenolic (OH) end groups with a Tg of 149° C. as per ASTM E1356 using a 20° C. heating rate. The PBT had a carboxylic acid (COOH) end group content of 47 meq/Kg with a 225° C. melting point. The blend was stabilized against melt transesterification by addition 0.1 to 0.3 wt. % of acidic zinc (MZP) or sodium (SDP) phosphate salts. The blend were stabilized against oxidation by a high molecular weight (Mw) hindered phenol with a molecular formula of C₃₅H₆₃O₃, (octadecyl 3-(3,5-di-tert-butyl-4-hydroxyphenyl)propionate, IRGANOX 1076™).

Other blends contained a high molecular weight C₃₀H₂₉N₃O benzotriazole UV absorber: 2-(2-hydroxy-5-tert-octyl phenyl) benzotriazole, TINUVIN 234™ and a low odor, high Mw thioester: pentaerythritol tetrakis (β-laurylthiopropionate; SEENOX 412S™, C₆₅H₁₂₄O₈S₄, Mw=1161.9. A key ingredient to obtaining the surprising improvements noted in this invention was from a core shell rubber (MBS). The MBS was spherical and had an average particle size of 180 nm with ˜75 wt. % polybutadiene core with ˜25 wt. % of a grafted poly methyl methacrylate styrene shell.

The invention was shown effective in PC with no PBT using the composition of Table 3 wherein the PC was combined with a phosphite; tris (2,4-di-tert butyl phenyl) phosphite, IRGAFOS 168™, C₄₂H₆₃O₃P, Mw=646.9, the core shell MBS and a high molecular weight ester lubricant, PETS.

The compositions of Tables 2 and 3 were formed into a monofilament with a diameter of 1.75 mm with deviation in diameter of less than 100 micrometers. The spooled filament was dried to less than 0.1% moisture and used in a MAKERBOT™ Replicator 2x with a nozzle/print head temperature of 275° C. and base plate temperature of 180° C. to make various test parts.

Parts were made using three different configurations. In one configuration all the melted monofilaments were laid down on top of each other along the long axis of the part (parallel).

In a second configuration the monofilaments were laid down across the short axis of the parts (perpendicular). In the third configuration the filaments were laid in a diagonal pattern with each layer crossing over the other at a 45 degree angle in an alternating direction (45-degree, crisscross). The parts were about 3.2×197 mm type 1 tensile bars comprising about 17 layers all having a perimeter that was filled in using one of the three configurations.

The test bars had some internal voids many of which had a tear drop, non-round shape with sharp (<60 degree) cusp angle. The top surface of the parts had a grooved structure with regular repetitive pattern separated by about 0.5 to 1.5 mm.

PC-PBT-MBS Blends: The PC-PBT parts were tested for tensile properties as per ASTMD638 at a cross head speed of either 5 or 50 mm/min. Tensile modulus was measured as tangent. The results of the test are shown in Tables 4 and 5. Parts were conditioned for 3 days at 23C, 50% relative humidity prior to testing.

TABLE 4
PC-PBT Blends Tensile testing at 5 mm/min

| | | Modulus of | Tensile | |
|---|---|---|---|---|
| Exam- | | Elasticity | Str. (B) | Elong. @ |
| ple | Strand Orientation | (MPa) | MPa | Break (%) |
| 1 | PC-PBT-MBS-Parallel | 2157 | 40.5 | 109 |
| 2 | PC-PBT-MBS- | 2013 | 37.1 | 50 |
| | Perpendicular | | | |
| 3 | PC-PBT-MBS-45 degree | 2187 | 37.9 | 108 |
| A | PC-PBT-EMA/GMA- | 2360 | 42.8 | 35 |
| | Parallel | | | |
| B | PC-PBT-EMA/GMA- | 2253 | 46.0 | 7 |
| | Perpendicular | | | |
| C | PC-PBT-EMA/GMA-45 | 2323 | 40.4 | 2 |
| | degree | | | |
| D | PC-PBT-Parallel | 2567 | 49.4 | 118 |
| E | PC-PBT-Perpendicular | 2623 | 48.1 | 4 |
| F | PC-PBT-45 degree | 2320 | 35.4 | 2 |

TABLE 5
PC-PBT Blends Tensile testing at 50 mm/min

| | | Modulus of | Tensile | |
|---|---|---|---|---|
| Exam- | | Elasticity | Str. (B) | Elong. @ |
| ple | Strand Orientation | (MPa) | MPa | Break (%) |
| 1 | PC-PBT-MBS-Parallel | 2167 | 41.5 | 38 |
| 2 | PC-PBT-MBS- | 1777 | 38.8 | 33 |
| | Perpendicular | | | |
| 3 | PC-PBT-MBS-45 degree | 1820 | 38.5 | 67 |
| A | PC-PBT-EMA/GMA- | 2310 | 45.4 | 14 |
| | Parallel | | | |
| B | PC-PBT-EMA/GMA- | 2207 | 51.3 | 5 |
| | Perpendicular | | | |
| C | PC-PBT-EMA/GMA-45 | 2200 | 38.8 | 3 |
| | degree | | | |
| D | PC-PBT-Parallel | 2557 | 46.3 | 59 |
| E | PC-PBT-Perpendicular | 1903 | 38.1 | 4 |
| F | PC-PBT-45 degree | 2447 | 41.3 | 2 |

As can be seen the orientation of the filaments (strand) did have an effect of part performance. With stands aligned in the same direction as the applied tests force (parallel) giving the best elongation at break. In this case the interfaces between neighboring filaments are parallel to applied force and therefore not subjected to tensile forces. The perpendicular orientation, having more strand to strand contact subject to the applied force, gave lower values. In this case, the interfaces are subjected to maximum force during tensile test as they are perpendicular to the applied load. The 45-degree orientation gave a balance of performance with less directional variation.

Surprisingly, in most orientations the core shell modified PC-PBT-MBS blends (examples 1, 2 and 3) had higher elongation at break at both the slow (>50%) and fast speed (>33%). The MBS blends also had a tensile modulus of over 2000 psi at slow speed and over 1700 psi at high speed. The PC-PBT-MBS blends also showed less change in properties with strand orientation than the PC-PBT blends (examples D,E and F) and the EMA/GMA rubber modified blends (examples A,B and C). The tensile elongation at break of injection molded PC-PBT-MBS blends was 120%.

The ductility of the PC-PBT blend monofilament additive manufactured parts was further tested for notched Izod (NI) impact (23° C.), as per ASTM D256. Samples (3.2×7.6 mm) were cut from the center portions of the three types of tensile bars as described above with a notch cut through the perimeter and some of the interior structure. As shown in Table 6 the PC-PBT-MBS blend (examples 1, 2 and 3) all have ductile failures with a notched Izod (NI) impact of over 500 J/m. There is also much less loss of impact with change in strand orientation vs. the PC-PBT and EMA/GMA rubber modified control examples A-F.

TABLE 6
PC-PBT Blends NI Impact testing

| Exam- | | NI Impact |
|---|---|---|
| ple | Strand Orientation | (J/m) |
| 1 | PC-PBT-MBS-Parallel | 611 |
| 2 | PC-PBT-MBS-Perpendicular | 515 |
| 3 | PC-PBT-MBS-45 degree | 826 |
| A | PC-PBT-EMA/GMA-Parallel | 465 |
| B | PC-PBT-EMA/GMA- | 64 |
| | Perpendicular | |
| C | PC-PBT-EMA/GMA-45 | 115 |
| | degree | |
| D | PC-PBT-Parallel | 61 |
| E | PC-PBT-Perpendicular | 25 |
| F | PC-PBT-45 degree | 29 |

One challenge in using use crystalline materials like PBT in monofilament additive manufacturing is the poor melt strength of the polyester. Once above the crystalline melting point, the resin has very low viscosity, the melting monofilament cannot support its weight and become too thin to make good uniform parts. There is also a tendency to form thin strings as the melt stretches forming fibers as the printing head changes position. This problem is solved by addition of an amorphous polymer like PC to the crystalline polyester blend. The PC improves melt elasticity and raise viscosity allowing the melting monofilament to support its own weight giving a uniform deposition of layers with no thin fiber formation as the head moves during printing. The polyester formulation gives parts with good solvent resistance (for example, resistance to ketones) while the PC allows for the melt processability to allowing facile monofilament additive manufacturing. In the making of the AM parts described above (examples 1-3) and even those with no MBS (examples A-F), the monofilaments showed good melt strength and did not show undue attenuation or the formation of fibers as the printing head moved. The PC-PBT blends had a viscosity at shear rate below 1500 1/sec of above 100 Pascal seconds (Pa-s) even at 300° C. At shear rates below 50 1/sec the viscosity is above 200 Pa-s at 300° C.

PC-MBS Blends: The invention was further demonstrated in a PC blend with no PBT. The compositions of Table 3 were formed into monofilaments which were formed into additive manufactured test bars as described above. The compositions comprised 0.05 wt. % of a phosphite stabilizer: tris (2,4-di-tert butyl phenyl) phosphite, IRGAFOS 168™, C₄₂H₆₃O₃P, Mw=646.9, 0.27 wt. % of a high molecular weight ester lubricant: PETS and 5 wt. % of a core shell MBS. Tensile and Izod bars were made with a MAKERBOT™ Replicator 2X at 320° C. print head/nozzle temperature and a 200° C. plate temperature using a perimeter with a 45-degree crossing pattern of the fill in.

Table 7 show the tensile properties and notched Izod impact (23° C.) for the PC-MBS blend and typical values for PC AM parts. While having a tensile modulus above 1700 psi, the PC-MBS blend (example 4) has a notched Izod (NI) impact above 660 J/m with 100% ductile failure. Elongation at break (using a 50 mm/min crosshead speed) is 48%. This represented a significant improvement over the more brittle PC parts (example G). The injection molded PC-MBS blend had an elongation at break 118% of and Notched Izod 579 J/m.

TABLE 7
PC-MBS Blends FFF-Additive Manufacture

| Exam- | | |
|---|---|---|
| ple | G | 4 |
| Material | PC | PC-MBS |
| Tensile Modulus (MPa) | 1950 | 1722 |
| Tensile Strength (MPa) | 50 | 39 |
| Elongation @ Break (%) | 5 | 48 |
| NI Impact Strength (J/m) | 45 | 696 |

Chemical analysis of the PC-MBS material showed that prior to making the AM part the composition had 223 ppm of the high Mw hindered phenol antioxidant and 386 ppm of the phosphite. There was only 66 ppm of the tris (2,6-di tert butyl phenyl) phosphate. The AM part showed good retention of the hindered phenol with 204 ppm remaining. The AM process, however, caused a chemical conversion of the phosphite; its content dropped to only 40 ppm while the tris (2,6-di tert butyl phenyl) phosphate was now the dominant phosphorous species at 386 ppm.

The examples of the invention made by monofilament additive manufacturing have improved impact and toughness, as shown by a comparatively high (>33%) tensile elongation at break and high (>400 J/m) Izod impact vs. AM parts made with PC compositions without a core shell rubber.

In some instances, core shell rubber-modified AM parts approach the impact properties of injection molded parts, which with superior packing of the molten resin under pressure and high temperature, have properties above that obtained by the lower pressure monofilament additive manufacturing process. Injection molded parts of the compositions of Table 2 and 3 may have an elongation at break above 100% with an Izod impact of at least 500 J/m at 23° C.

### ADDITIONAL EXAMPLES

Polycarbonate (PC) with 5 wt % of various rubbery modifiers: an acrylic core shell rubber, a silicone acrylic core shell rubber, two different ABS (acrylonitrile butadiene styrene) graft rubbers, and an ASA (acrylonitrile styrene acrylate) rubber was extruded with 0.2 wt % trialkyl phosphite stabilizer (IRGAPHOS 168) and 0.27 wt % pentaerythritol tetrastearate (PETS) mold release and formed into pellets. The PC was a 90:10 wt % mixture of low molecular weight (Mw=21,900) and high Mw (Mw=29,900) BPA polycarbonate. Mw was determined by GPC using PC standards. The blends had a PC Tg of 146 to 148C as determined by DSC using a 20 C/min heating rate. Phenolic end groups were less than 100 ppm with bromine and chlorine content less than 200 ppm. These compositions are shown in Table 8.

Some of the pellets were formed into injection molded Izod bars and the remainder made into monofilaments with a diameter of 1.75 mm with a variation in diameter of less than 5%. These monofilaments were fed into a MAKERBOT Replicator 2X printer and formed into Izod bars made using an additive manufacturing process of depositing successive monofilament layers with a nozzle temperature of 320 C and a 200 C base plate temperature. The bars were 175×12.5×3.2 mm and were made using a flat orientation with an alternating 45 degree crossing pattern and had 17 layers. Both the injection molded and additive manufactured (FFF-AM) bars were tested for notched Izod impact as per ASTM D256. A set of injection molded and FFF additive manufactured parts were made in the same fashion using a polycarbonate composition with no rubbery modifier. The injection molded bars were solid with no porosity the FFF-AM parts contained some non-round voids. As can be seen in Table 9 the notched Izod impact (NI) for the FFF-AM parts with 5% core shell or graft rubbers had from 74.5 to 89.7% of the Izod impact of the injection molded bars. In all instances the NI impact was above 300 J/m and in most instances above 400 J/m and showed ductile failure. On the other hand the PC control with no added rubber was brittle and had only a 12.1% retention of the injection molded impact in these experiments having a low Izod impact of less than 200 J/m. While not held to any particular mechanism we believe that the rubber modifier helps with interfilament adhesion improving the mechanical properties of the FFF-AM parts vs. a monolithic PC monofilament manufactured parts with no core shell or graft rubber.

TABLE 8
PC Rubber Blend Composition

| | Example | | | | | |
|---|---|---|---|---|---|---|
| | G | 5 | 6 | 7 | 8 | 9 |
| PC Mw 21,900 | 90 | 85.5 | 85.5 | 85.5 | 85.5 | 85.5 |
| PC Mw 29,900 | 10 | 9.5 | 9.5 | 9.5 | 9.5 | 9.5 |
| Acrylic Impact Core-Shell | 0 | 5 | 0 | 0 | 0 | 0 |
| Rubber | | | | | | |
| Silicone-Acrylic Core-Shell | 0 | 0 | 5 | 0 | 0 | 0 |
| Rubber | | | | | | |
| Blendex 338 ABS Graft | 0 | 0 | 0 | 5 | 0 | 0 |
| Rubber | | | | | | |
| 362 VHRG ABS Graft | 0 | 0 | 0 | 0 | 5 | 0 |
| Rubber | | | | | | |
| ASA - Graft Rubber | 0 | 0 | 0 | 0 | 0 | 5 |
| Phosphite | 0.2 | 0.2 | 0.2 | 0.2 | 0.2 | 0.2 |
| Pentaerythritol Tetrastearate | 0.27 | 0.27 | 0.27 | 0.27 | 0.27 | 0.27 |

TABLE 9
PC Rubber Blends N Izod Injection Molding vs. FFF-Additive Manufacture

| | | N Izod J/m | N Izod J/m | | |
|---|---|---|---|---|---|
| Exam- | | Injection | FFF- | % N Izod | % |
| ple | Composition | Molded Parts | AM Parts | Retention | Ductility |
| G | PC no rubber | 917 | 111 | 0.1 | 0% |
| 5 | PC-5% Acrylic Rubber | 642 | 531 | 0.8 | 100% |
| 6 | PC-5% Silicone | 627 | 473 | 0.8 | 100% |
| | Acrylic Rubber | | | | |
| 7 | PC- 5% ABS Rubber | 612 | 549 | 0.9 | 100% |
| 8 | PC-5% VHRG ABS Rubber | 651 | 547 | 0.8 | 100% |
| 9 | PC-5% ASA Rubber | 459 | 342 | 0.7 | 100% |

In further experiments (examples 10 and 11) Izod bars using the PC-PBT-MBS blend of Examples 1, 2 and 3 and a PC-MBS blend of Table 7 Example 4 were printed on the FORTUS AM printer using a profile comprising a nozzle temperature of 315° C. and an oven temperature of 95° C. in an on-edge orientation As shown in Table 10, these FFF-AM parts have an Izod impact that is 45.6% and 44.6% of the impact strength of an injection PC-PBT-MBS or PC-MBS molded part. The PBT-PC-MBS and PC-MBS blends showed ductile failure.

This is a significant improvement over standard PC with no rubber where the unmodified PC parts, made on the same machine using the same orientation, show an Izod impact of about 60 J/m, which is less than 10% of the injection molded value with PC-AM parts showing brittle failure.

TABLE 10
FORTUS FFF-AM Izod impact PC-PBT-MBS Blends

| | | N Izod J/m | N Izod J/m | |
|---|---|---|---|---|
| Exam- | | Injection | FFF- | % N Izod |
| ple | Composition | Molded Parts | AM Parts | Retention |
| 10 | PC-PBT-MBS | 689 | 314 | 45.6% |
| 11 | PC-MBS | 579 | 258 | 44.6% |

The Izod impact while still improved over the unmodified PC and PC-PBT is not as high as parts made with the MAKERBOT™ FFF-AM printer (examples 1, 2 and 3 in Table 6).

As demonstrated, there is improvement in the AM parts made using PC blends with a core shell or graft rubber over an unmodified PC with no rubber. The full extent of improvement (higher retention of injection molded Izod impact or elongation at break) may vary with the AM machine and settings used as well as the part design (e.g., fill pattern).

What is claimed:

1. An additively-manufactured article, comprising:
at least 10 layers made from a composition;
the composition comprising an amorphous polymer phase and at least one core-shell or graft rubber modifier material;
the amorphous polymer being at least 50% of the weight of the at least 10 layers of the article;
the amorphous polymer having a Tg of from about 110 to about 200 deg. C;
the amorphous polymer having a molecular weight of at least 10,000 Da as per ASTM D5296;
the least one core-shell rubber modifier material, if present, having a number average diameter of from 100 to 400 nm, and being present at from about 1 to about 30% of the weight of the composition;
the article further having a surface roughness with a vertical deviation of from 0.01 to 0.1 mm; and
the article still further having (a) a tensile elongation at break, as per ASTM D638, of from about 20% to about 99% the elongation at break value of a corresponding inj ection-molded article, (b) a notched Izod impact strength, as per ASTM D256, of from about 20% to about 99% of the notched Izod impact strength of a corresponding injection-molded article, or both (a) and (b).

2. The article of claim 1, wherein the composition comprises at least 50 ppm of a phosphorous compound having a molecular weight of over 300 Daltons and comprising a phosphate, mixtures of phosphates or mixtures thereof, and wherein, if present, aryl phosphite is at a lower concentration than aryl phosphate.

3. The article of claim 1, wherein the composition further comprises a hindered phenol antioxidant comprising at least 20 carbon atoms.

4. The article of claim 1, wherein the article has a notched Izod impact strength, per ASTM D256, of above about 300 Fm.

5. The article of claim 1, wherein the article has (a) a density as measured by ASTM D792 of 80.0% to 99.5% by weight of a corresponding injection molded article and (b) a micro structure, as measured by optical microscopy, containing from 1% to 20% by volume of voids.

6. The article of claim 5, wherein at least 60% of the voids are high aspect voids and less than 20% of the voids are spherical voids having a diameter of from 10 to 100 microns.

7. The article of claim 1, wherein the composition is in monofilament form and has a variation along its diameter of less than about 100 micrometers.

8. The article of claim 7, wherein the monofilament comprises a plurality of concavities, a plurality of protrusions, or both.

9. The article of claim 1, wherein the amorphous polymer is an aryl polycarbonate with a Tg of from about 130 to about 200 deg. C and having a phenolic end group content of less than 50 ppm.

10. The article of claim 1, the composition further comprising a crystalline polymer phase, the crystalline polymer being at least 10% of the at least 10 layers and the crystalline polymer having a Tm of from about 150 to about 280 deg. C and a molecular weight of at least 10,000 Da.

11. The article of claim 10, wherein the crystalline polymer has a Tm of from about 200 to about 250 deg. C, and wherein the crystalline polymer has a carboxylic acid end group content of from about 10 to about 60 meq/kg.

12. The article of claim 10, wherein the crystalline phase comprises a polyester, a polyamide, or both.

13. The article of claim 12, wherein the polyester comprises one or more of PBT, PET, PPT and PEN, and wherein the polyester has a carboxylic end group content of at least 20 ppm.

14. The article of claim 1, wherein the composition comprises polycarbonate and a polyester, wherein the composition comprises an acidic quencher present at 0.05 to 3.0 wt. % measured against the weight of the monofilament material used to make the article, and wherein the acidic quencher comprises one or more of: acidic phosphate salts, polyacid pyrophosphates and salts thereof, phosphate salts of a Group IB or Group IIB metals and phosphorous oxo-acids, or any combination thereof.

15. The article of claim 1, wherein the composition when melted has a viscosity, as measured by ISO method 11443:2005 at a shear rate of between 10 and 100 sec⁻¹, above about 500 poise at a temperature from 30 to 100 deg. C above the Tm of the crystalline polymer.

16. The article according to claim 1, wherein the shell of the core shell rubber modifier, if present, comprises from 5 to 30 wt. % of the modifier and wherein the rubbery core comprises 70 to 95 wt. % of the core shell rubber modifier.

17. The article of claim 1, wherein the core shell rubber modifier, if present, (a) comprises a shell comprising any combination of alkyl acrylates, alkyl methacrylates, glycidyl methacrylate, styrene, methyl styrenes and acrylonitrile and (b) comprises a core comprising a butadiene, alkyl acrylate, or silicone acrylate rubber having a Tg of less than 30 deg. C.

18. The article of claim 1, wherein the core-shell modifier, if present, comprises MBS, HRG-ABS, acrylic rubber or any combination thereof.

19. The article of claim 1, wherein the composition is in filament form, pellet form, particulate form, or any combination thereof.

20. A method, comprising:
with a composition according to claim 1, additively manufacturing at least a portion of an article, wherein the additively manufacturing comprises fused filament fabrication, fused particulate additive manufacturing, large format additive manufacturing, or any combination thereof.
